(19) United States
(12) Patent Application Publication
(10) Pub. No.: US 2014/0263024 A1
(43) Pub. Date: Sep. 18, 2014

(54) HALOGEN RESISTANT AMIDES, POLYAMIDES, AND MEMBRANES MADE FROM THE SAME

(71) Applicants: Andrew Patrick Murphy, Littleton, CO (US); Robert Lee Riley, La Jolla, CA (US); Yuliana Elvira Porras Mendoza, Arvada, CO (US)

(72) Inventors: Andrew Patrick Murphy, Littleton, CO (US); Robert Lee Riley, La Jolla, CA (US); Yuliana Elvira Porras Mendoza, Arvada, CO (US)

(21) Appl. No.: 13/828,630

(22) Filed: Mar. 14, 2013

(51) Int. Cl. B01D 71/56

(52) U.S. Cl. CPC B01D 71/56
USPC 210/321.6; 210/500.28; 528/367

(57) ABSTRACT

A halogen resistant polyamide is formed from the reaction product of an amine monomer and an acid chloride monomer wherein the amino group of the starting amine monomer is separated from the aromatic amine ring system by an alkyl group and (i) minimizes halogenation on the amine and (ii) minimizes N-halogenation at a pH range of approximately 7 to approximately 10.5. A membrane is made from the polyamide for use, for example, in a reverse osmosis desalination unit.

### BACKGROUND OF THE INVENTION

1. Field of the Invention

The present invention relates to chlorine resistant amide polymers and to membranes made from such and to methods of using said polymers and membranes.

2. Description of the Related Art

The desalting membrane of choice worldwide is a polyamide (PA) membrane. PA membranes are made by forming a thin PA film on a finely porous surface of a polysulfone (PS) supporting membrane by an interfacial reaction between the reactant pair trimesoyl chloride (TMC) and m-phenylenedimaine (MPD). The following equation illustrates the chemical formation of a PA desalination barrier:

[chemical structure]

In the above equation, the first term represents m-phenylenediamine in water, the second term represents the trimesoyl chloride in hydrocarbon, and the resultant term represents the fully aromatic polyamide thin film. This is the equation for the PA thin-film composite membrane developed by Cadotte and E. E. Erickson (Desalination, Volume 32, 25-31, 1980) and, as indicated above, is the membrane in common use throughout the world.

A great need exists to improve the stability of the present state-of-the-art membranes used for chlorine disinfection. Such improvement is critical, for example, in reverse osmosis (RO) plants operating on wastewaters, surface waters, and open seawater intakes wherein disinfection by chlorination is required to control the growth of microorganisms (so-called biofouling) on the surface of the membrane. These PA membranes are so susceptible to deterioration by chlorine that a dechlorination step is required when chlorine is used as a disinfectant in the pretreatment. It will be understood that dechlorination prior to the PA membrane creates additional costs and effectively nullifies disinfection on the membrane surface where disinfection is needed. It is also noted that such dechlorination does not neutralize all chlorine, and the small amount of residual chlorine shortens membrane life.

U.S. Pat. No. 7,806,275 (Murphy et al) teach chlorine resistant polyamides modified with electron-withdrawing groups are useful to make PA membranes, useful in desalination units, that exhibit sufficient activity to minimize any chlorination on both the amine and acid chloride side and minimize N-chlorination. The patent states that attempting to add electron-withdrawing groups to the amine side of the membrane would create a number of problems including: (1) difficulties in obtaining precursors and overall synthesis; (2) an increase in electron-withdrawing away from the nitrogen; (3) resonance problems resulting in ring chlorination; (4) water solubility problems arising from the addition of hydrophobic groups; (5) less reactivity during interfacial polymerization; and (6) all successful membranes made based on amine modification show problems with flux.

While there are various PA membranes useful for desalination, there still remains a need in the art to improve the chlorine stability of reverse osmosis (RO) membranes. The present invention, different from prior art systems, provides such a membrane that is useful and critical, for example, for desalination in reverse osmosis plants.

### SUMMARY OF THE INVENTION

It is therefore an object of the present invention to provide a halogen resistant polyamide made from the reaction product of an amine monomer and an acid chloride to form a polymer wherein each amino group of the starting amine monomer is separated from the aromatic amine ring by an alkyl group.

Another object of the present invention is to provide a halogen resistant polyamide membrane that is halogen resistant at a pH range of approximately 7 to approximately 10.5, made from the reaction product of an amine monomer and an acid chloride to form a polymer wherein the starting amine monomer is an aromatic amine such as m-xylylene diamine; o-xylylenediamine; p-xylylenediamine; α,α′-dimethyl-1,3-xylylene diamine; α,α,α′,α′-tetramethyl-1,3-xylylene diamine; 1,3,5-tri(aminomethyl)benzene; and mixtures thereof.

With at least one amino group and each amino nitrogen is separated from the amine ring system by an alkyl group such as a methyl group for example and the alkyl hydrogens can be replaced with alkyl groups including a methyl group.

A still further object of the present invention is to provide a halogen resistant polyamide membrane made from the reaction product of an amine and an acid chloride to form a polymer that is halogen resistant at a pH range of approximately 7 to approximately 10.5, wherein each amino group of the starting amine monomer is separated from the aromatic amine ring system by an alkyl group, such as for example a methylene group, and said acid chloride is selected from the group consisting of trimesoyl chloride (TMC), monofluorotrimesoyl (MFTMC), perfluorotrimesoyl chloride (PFTMC), nitrotrimesoyl chloride (NTMC), perchlorotrimesoyl chloride (PCTMC) 1,3,5-benzenetri-(difluoroacetoyl chloride), isophthaloyl chloride (IPC) and mixtures thereof.

A still further object of the present invention is to provide a halogen resistant polyamide that is halogene resistant at a pH range of approximately 7 to approximately 10.5, made from the reaction product of an amine and an acid chloride to form a polymer wherein each amino group on the starting amine monomer is separated from the aromatic amine ring system by an alkyl group such as for example a methylene group and said amine is m-xylylenediamine; o-xylylenediame; p-xylylenediamne α,α′-dimethyl-1,3-xylylene diamine; α,α,α′,α′-tetramethyl-1,3-xylylene diamine; 1,3,5-tri(aminomethyl)benzene; and mixtures thereof.

Another object of the present invention is to provide a desalination unit having a membrane support that includes a halogen resistant polyamide membrane wherein the halogen resistant polyamide membrane is a reaction produce of an amine and an acid chloride monomer wherein each amino group of the starting amine monomer is separated from the aromatic amine ring system by an alkyl group such as for example a methylene group and exhibits activity to (i) minimize N-halogenation and ring halogenation at a pH range of approximately 7 to approximately 10.5.

A still further object of the present invention is to provide a desalination unit having a membrane support that includes a halogen resistant polyamide membrane wherein the halogene resistant polyamide membrane is a reaction product of an amine and an acid chloride monomer wherein each amino group on the amine monomer is separated from the aromatic amine ring system by an alkyl group such as a methylene group(s) and exhibits activity to (i) minimize N-halogenation and ring halogenation at a pH range of approximately 7 to approximately 10.5, wherein said amine of said chlorine resistant membrane is selected from the group consisting of m-xylylenediame, α,α′-dimethyl-1,3-xylylene diamine; α,α,α′,α′-tetramethyl-1,3-xylylene diamine; 1,3,5-tri(aminomethyl) benzene; and mixtures thereof.

A still further object of the present invention is to provide a desalination unit having a membrane support that includes a halogen resistant polyamide membrane wherein the halogen resistant polyamide membrane is a reaction produce of an amine and an acid chloride monomer wherein each amino group of the starting amine monomer is separated from the aromatic ring structure of the amine monomer by an alkyl group such as methylene group and exhibits activity to (i) minimize any halogenation on the amine and (ii) minimize N-halogenation at a pH range of approximately 7 to approximately 10.5, wherein said acid chloride is selected from the group consisting of trimesoyl chloride (TMC), monofluorotrimesoyl (MFTMC), perfluorotrimesoyl chloride (PFTMC), nitrotrimesoyl chloride (NTMC), perchlorotrimesoyl chloride (PCTMC) 1,3,5-benzenetri-(difluoroacetoyl chloride), isophthaloyl chloride and mixtures thereof.

Further objects and advantages of the invention will become apparent from the following description.

### BRIEF DESCRIPTION OF THE DRAWINGS

FIG. 1 is a perspective view of a desalination membrane unit.

### DETAILED DESCRIPTION OF THE INVENTION

The present invention is a new approach for producing novel polyamides to use, for example, in producing halogen resistant membranes, especially chlorine resistant membranes, for reverse osmosis and nanofiltration membranes. This invention can also be used to make other plastic items such as, for example, films and tanks. The amides can also be used, for example, by the plastic and rubber industry, paper industry, water and sewage treatment industry, in crayons, pencils, and inks. Amines, amides, polyamides (linear, cross-linked, low and high molecular weight) described in the present specification, would benefit by these chlorine resistant properties demonstrated in this patent.

The term halogen is used herein to have the same meaning as commonly understood by one of ordinary skill in the art to which the invention belongs and includes fluorine, chlorine, bromine, iodine and astatine. The present invention is exemplified and explained using membranes that are chlorine resistant.

The polyamide (PA) spiral-wound thin-film composite membrane elements that are used today are not tolerant to chlorine. The membranes in use today degrade and lack chemical stability to oxidants such as chlorine. Yet, chlorine is a very effective biocide in water treatment and is desirable. By having a chlorine resistant membrane, desalting plants and mobile desalting units can operate in a more robust fashion, saving costs on membrane cleaning, storage, replacement, and general overall operating expenses.

One aspect of the invention is a chlorine resistant polyamide made from the reaction of an amine monomer and an acid chloride wherein the amine monomer includes amines having an aromatic ring system wherein said ring can include 5 to 7 carbons and can be saturated (cycloaliphatic) or unsaturated. The amine can also be an aliphatic amine with no ring system. With amines having a ring system, each amino group on a starting amine monomer is modified with an alkyl group such as for example, a methylene group, separating the aromatic amine ring from the amino group. This minimizes N-chlorination and ring chlorination at a pH range of approximately 7 to approximately 10.5. The polyamides of the present invention must be fairly straightforward to synthesize from commercially available precursors to avoid high costs of making the compounds.

Another aspect of the present invention is a chlorine resistant polyamide membrane wherein each amino group of a starting amine monomer is separated from the aromatic amine ring system by an alkyl group, such as for example, a methylene group, which minimizes ring chlorination and minimizes N-chlorination as well at a pH range of approximately 7 to approximately 10.5. Also included in the present invention is an amine monomer having an alkyl group such as for example a methylene group, separating the amino group from the aromatic ring system wherein in the alkyl group hydrogens can be substituted with alkyl groups including for example a methyl group. The addition of an alkyl group between the ring and the amide nitrogen eliminates the substitution effects of groups on the aromatic ring, either electron donating or electron withdrawing, and prevents the lone electron pair on the amide nitrogen form ‘spilling over’ with the pi orbitals of the aromatic ring in the process called resonance, resulting in changes to the chemical reactivity of the amide nitrogen. In the polyamide thin film composite (TFC) membrane, the film is a highly cross-linked polymer in which the amide bonds can be seen from the amine ring with the electronics figured out to favor ortho and para substitution as follows:

[chemical structure]

Note the double effect from both groups adding to the reactivity of the sites. Now, due to sterics, the most unlikely site would be ortho to both amide bonds, which leaves the other two sites most likely for attach by chlorine which is confirmed by NMR data below in the examples.

By adding a methylene group to the amine:

[chemical structure]

The problem associated with ring chlorination by the above mechanism can be eliminated. Further, the reactivity of the nitrogen on the amide bond would be changed due to resonance:

[chemical structure]

The above shows that the more positive nitrogen would react with hypochlorite ion, the predominate form at pH approximately 8.0, and the following two reactions would favor k1>>k2 because of the electron density shift into the aromatic ring by the lone pair on the nitrogen. Glater et al. (Desalination, Volume 95, 325-345, 1994) shows that ring chlorination follows on the amine ring (see k1 above) from an Orton rearrangement which then leads to further polymer/membrane degradation. This would not be the case for K2 above due to the methylene group.

The following equation is an example of the reaction to make the new polyamides and membranes of the present invention. Note the methylene group between the amino group and the aromatic amine ring:

[chemical structure]

Another aspect is the use of these membranes in a reverse osmosis desalination unit that includes a membrane support, a chlorine resistant membrane supported on the membrane support wherein the chlorine resistant membrane is a reaction product of an amine and an acid chloride wherein the amine of a polyamide is modified with an alkyl group, such as for example a methylene group, separating the amide ring structure from an amino group that minimizes ring chlorination on the amine side and minimizes N-chlorination at a pH range of approximately 7 to approximately 10.5. An additional requirement is that these membranes of the present invention have good transport properties of salt rejection and flux.

The following acid chloride has been found to be effective for use in synthesizing the chlorine resistant polyamide membrane of the invention:

[chemical structure]

This compound is trimesoyl chloride (TMC), and is available and used today in the successful TMC-MPD membrane of industry. This is a preferred embodiment of the invention but other acid chlorides could be used too primarily to improve membrane transport properites.

The following amine monomer is an example of one aromatic amine has been found to be effective for use in synthesizing the chlorine resistant polyamide membrane of the present invention:

m-xylylenediamine (MXD):

[chemical structure]

The commercial amine, MPD, has been modified with a methylene group separating the aromatic amine ring from the amino groups. This results in a chlorine resistant polymer at a pH range of approximately 7 to approximately 10.5.

The following membrane is an example of a membrane of the present invention:

[chemical structure]

In the examples that follow, a new class of polyamides and polyamide membranes is exemplified showing chlorine resistant. It will be appreciated that chlorine resistant PA amides, polymers (linear, cross-linked, high and low molecular weight) should find a wide range of application in industry. Application could include linear and highly cross-linked polyamide polymers for the production of pipes, tanks and the like, fibers in clothing, chemically resistant coatings, flame retardant materials (due to the halogen groups), and chlorine resistant surfactants. Further, even in the area of membranes there is more than RO, and filtering processes such as microfiltration (MF), nanofiltration (NF), and ultrafiltration (UF) could all benefit from PA polymers having improved chlorine resistance.

Although the invention has many different applications as discussed above, one important application is in the manufacture of reverse osmosis (RO) membranes.

Referring to FIG. 1, a spiral wound RO membrane unit 10 is shown which is typical of those currently used in desalting plants. Unit 10 includes a membrane element 12 which is constructed in accordance with the present invention. Because element 10 is conventional apart from membrane 12 and moreover, the appearance of membrane 12 would not be different for a conventional membrane, unit 10 will be only briefly described below by way of background. It will also be understood that membranes made by the methods of the present invention can be used in different membrane units than that shown in FIG. 1.

Unit 10 includes an outer pressure vessel 14 typically made of fiberglass with an anti-telescoping device or shell 16 at opposite ends thereof. An axially extending product tube 18 is located centrally of element 10, as shown. The membrane element 12 itself includes a salt rejecting membrane surface 12a which forms part of a membrane leaf 12b including a tricot spacer 12c, a mesh spacer 12d, and a membrane 12e. It will be appreciated that the membrane element 12 is the key component of unit 10 and defines the actual surface where salt is separated from water. In embodiments of the present invention, the membrane is made from the chlorine resistant polyamide of the present invention.

As described above, one aspect of the present invention is modifying polyamide polymers so they exhibit chemical stability in chlorine water environments at a pH range of approximately 7 to approximately 10.5. Because of the difficulty in obtaining chemical data from polymers, especially highly-cross linked polymer systems, the examples will show synthesis of amides which are then exposed to high concentrations of chlorinated water. These amides are smaller units; polyamides are composed of many amide units. However, the chemical principles, as discussed above, of these amides that have been found apply directly to polyamide polymers.

The following examples are offered to illustrate, but not to limit the invention and use chlorine resistant as a model for halogen resistance.

### Example 1

1,3-bis(benzoylamino methyl)benzene, referred to as Amide A (using the amine MXD), was synthesized using the corresponding amine and the anhydride, benzoic anhydride. The final product was recrystallized in acetone-water. The structure for this amide is:

[chemical structure]

The following NMR data supports the successful synthesis of this new amide based on chemical shift arguments, number of major resonances, relative integral values and using a chemical shift prediction program:

¹H NMR (500 MHz, DMSO-d6): δ 9.04 (t, J=6.0 Hz, 2H), 7.87 (d, J=7.0 Hz, 4H), 7.53 (t, J=7.0, 2H), 7.45 (m, 4H), 7.28 (m, 2H), 7.20 (m, 2H), 4.47 (d, J=6.0 Hz, 4H); ¹³C NMR (125 MHz, DMSO-d6) δ 166.0, 139.6, 134.2, 131.1, 128.1, 127.1, 125.7, 125.5, 42.4.

### Example 2

1,3-bis(benzoylamino)benzene, referred to as Amide B (using the amine, MPD), was synthesized as described in Example 1 and the structure for this amide is below:

[chemical structure]

The following proteon and carbon NMR data supports the successful synthesis of this new amide based on chemical shift arguments, number of major resonances, relative integral values, and using a chemical shift prediction program:

¹H NMR (500 MHz, DMSO-d6): δ 10.3 (s, 2H), 8.35 (s, 1H), 7.99 (d, J=7.5 Hz, 4H), 7.59 (m, 2H), 7.50-7.56 (m, 6H), 7.32 (t, J=8 Hz, 1H); ¹³C NMR (125 MHz, DMSO-d6): δ 165.4, 139.3, 134.9, 131.5, 128.5, 128.3, 127.6, 116.0, 112.9.

### Example 3

The amides prepared in Examples 1 and 2 were halogenated at pH 5.5 and 8 with phosphate buffers using chlorine exposure at approximately 660,000 ppm-hr. This would correspond to a reverse osmosis desalting plant operating at approximately 1 ppm Av. Cl₂ for over 75 years. This was in far excess of any expected membrane life of approximately 7-9 years. In addition, the three day exposure at approximately 9170 mg/L chlorine contained an added approximately 1,000 mg/L bromide ion. The bromide oxidizes in the free chlorine solution and was included because the feed water at the testing site contains bromide ion at a concentration of approximately 0.2 mg/L. Results presented in Table 1 below.

Amide A does not halogenate at pH 8.0. Although there is some chlorination at pH 5.5 for Amide A there is significant chlorination at pH 8.0 and pH 5.5 for Amide B. Table 1 lists only some of the masses of the halogenated compounds but a check of other masses show the bromo forms (mono, di, and tri) and chloro and bromo combinations exit for Amide A at pH 5.5 and for Amide B at pH 8.0 and 5.5. An example, not included in the table, is the mass at 583 which is C₂₀H₁₁N₂O₂Cl₃Br₂

TABLE 1
Liquid Chromatography - Mass Spectrometry
(LC-MS) for Amide A and Amide B

| | | Retention | Observed | | |
|---|---|---|---|---|---|
| | | Time | Mass | % Abundance | Molecular |
| Amide | pH | (min) | (Da) | In Spectrum | Formula |
| A | 8.0 | 9.29* | 344.3 | 94.5 | C₂₂H₂₀N₂O₂ |
| A | 5.5 | 9.28 | 344.3 | 90.6 | C₂₂H₂₀N₂O₂ |
| A | 5.5 | 10.36 | 378.3 | 82.6 | C₂₂H₁₉N₂O₂Cl |
| A | 5.5 | 11.89 | 412.2 | 50.81 | C₂₂H₁₈N₂O₂Cl₂ |
| A | 5.5 | 13.69 | 446.2 | 24.25 | C₂₂H₁₇N₂O₂Cl₃ |
| B | 8.0 | 10.30 | 316.4 | 81.0 | C₂₀H₁₆N₂O₂ |
| B | 8.0 | 11.75 | 350.8 | 86.7 | C₂₀H₁₅N₂O₂Cl |
| B | 8.0 | 12.49 | 385.2 | 38.0 | C₂₀H₁₄N₂O₂Cl₂ |
| B | 8.0 | 12.49 | 419.7 | 4.87 | C₂₀H₁₃N₂O₂Cl₃ |
| B | 5.5 | 13.43 | 316.4 | 3.38 | C₂₀H₁₆N₂O₂ |
| B | 5.5 | 11.71 | 350.8 | 26.0 | C₂₀H₁₅N₂O₂Cl |
| B | 5.5 | 12.58 | 385.2 | 71.9 | C₂₀H₁₄N₂O₂Cl₂ |
| B | 5.5 | 10.78 | 419.7 | 34.9 | C₂₀H₁₃N₂O₂Cl₃ |

Molecular formulas derived from monoisotopic mass
*single peak for sample
In addition, for amide A at pH 5.5 and amide B, a check of other masses show the bromo forms (mono, di, and tri) and chloro and bromo combinations such as the mass at 583 which is C₂₀H₁₁N₂O₂Cl₃Br₂. Further evidence of degradation of amide A at the undesirable pH of 5.5 and degradation of amide B.

### Example 4

The following two polymers were synthesized using the amines MXD and MPD, and the acid chloride isothaloyl chloride for halogenations experiments on linear polymers.

[chemical structure]

As can be seen from the structures, these polymers have the amide linkages of Amide A and Amide B and because these are polymers, they represent a closer extrapolation to the cross-linked polymers used for membranes.

The amides were halogenated at pH approximately 5.5 and approximately 8 with phosphates buffers using chlorine exposure of approximately 228,000 ppm-hr. This would correspond to a reverse osmosis desalting plant operating at approximately 1 ppm Av. Cl₂ for over 26 years. This was in far excess of any expected membrane life of approximately 7-9 years.

On these polymer samples, elemental analyses were performed for total chlorine. The Table 2 below presents the data at pH approximately 8.0. The data suggests that the linear MXD-IPC polymer (containing Amide A) at pH approximately 8.0 has considerably less chlorine atom per monomer unit (approximately 0.27) suggesting that there is only some chlorine addition. This data might represent chlorination of the unreacted end groups of the linear polymer or experimental error-perhaps incomplete washing of chloride ion from the polymer samples. Because of the LC-MS data on amide A at this pH failed to show any evidence of chlorination, it seems unlikely that N-chlorination, amide nitrogen chlorination, or ring chlorination occurred with this linear polymer. The MPD-IPC polymer (containing Amide B) polymer has greater than 1 chlorine atom per monomer unit (approximately 1.07) which suggests N-chlorination which could have advanced to ring chlorination and ultimately serious polymer chlorine degratdation. LC-MS data on amide B at this pH show serious halogenations in support of elemental analysis. The MXD-IPC (amide A) polymer is superior in chlorine resistance to the MPD-IPC (amide B). This suggests that a membrane made with MXD would be chlorine resistant.

TABLE 2
Percent Addition of Chlorine to Linear Polymers at pH 8

| | | | | | Final | Mole |
|---|---|---|---|---|---|---|
| | | | Chlorine | | Chlorine | Cl/ |
| | | | Exposure | Chlorine | % | monomer |
| Polymer | pH | Conditions | ppm-hrs | % w/w | w/w | unit* |
| MXD- | 8.0 | control | 0 | 0.73 | | |
| IPC | | | | | | |
| MXD- | 8.0 | residue | 228,000 | 4.29 | 3.56 | 0.27 |
| IPC | | | | | | |
| MPD- | 8.0 | control | 0 | 0.68 | | |
| IPC | | | | | | |
| MPD- | 8.0 | residue | 228,000 | 16.62 | 15.9 | 1.07 |
| IPC | | | | | | |

*266 Da for MXD-IPC and 238 Da for MPD-ICP

As seen in Table 3, at pH approximately 5.5, the linear MXD-IPC polymer (Amide A) has a greater chlorine atom per monomer unit (approximately 0.80) than the same polymer at pH approximately 8.0. The MPD-IPC polymer (Amide B) has a greater than one chlorine atom per monomer unit (approximately 1.65) which suggests more damage possibly N-chlorination and ring chlorination. The MXD-IPC polymer is superior to the MPD-IPC polymer at pH approximately 5.5. The MXD-IPC is superior in chlorine resistance to the MPD-IPC at pH approximately 5.5.

Because the feed water at RO desalination plants operate near pH approximately 8.0 and not pH approximately 5.5, the best results from these tables can be appreciated and membranes made with the MXD amine operated at near pH approximately 8.0 should demonstrate suiperior chlorine resistance properties compared to the existing commercial membranes made with MPD.

TABLE 3
Percent Addition of Chlorine to Linear Polymers at pH 5.5

| | | | | | Final | Mole |
|---|---|---|---|---|---|---|
| | | | Chlorine | | Chlorine | Cl/ |
| | | | Exposure | Chlorine | % | monomer |
| Polymer | pH | Conditions | ppm-hrs | % w/w | w/w | unit* |
| MXD- | 5.5 | control | 0 | 0.73 | | |
| IPC | | | | | | |
| MXD- | 5.5 | residue | 228,000 | 11.41 | 10.7 | 0.80 |
| IPC | | | | | | |
| MPD- | 5.5 | control | 0 | 0.68 | | |
| IPC | | | | | | |
| MPD- | 5.5 | residue | 228,000 | 25.31 | 24.6 | 1.65 |
| IPC | | | | | | |

*266 Da for MXD-IPC and 238 Da for MPD-ICP
In addition, for amide A at pH 5.5 and amide B, a check of other masses show the bromo forms (mono, di, and tri) and chloro and bromo combinations such as the mass at 583 which is C₂₀H₁₁N₂O₂Cl₃Br₂. This is further data supporting degradation of amide B and of amide A at the undesirable pH of 5.5.

### Example 6

This example shows halogenations of the amide and resonances that result from mistures of halogenated compounds at a buffered pH of approximately 5.5 on Amide B using the conditions described above in Example 3. The NMR data show a distribution of resonances that result from mixtures of halogenated compounds at a buffered pH of approximately 8.0 on Amide B (using the amine MPD. The following show one example of the ¹H NMR and ¹³C NMR data at pH approximately 8.0:

¹H NMR (500 MHz, DMSO-d6): δ 10.48 (s, 0.4H), 10.32 (s, 1.2H), 8.31-8.35 (m, 0.7H), 8.10-8.14 (m, 0.5H), 7.95-8.02 (m, 5.1H), 7.73-7.78 (m, 0.6H), 7.47-7.63 (m, 10.0H), 7.30 (t, J=8.0 Hz, 0.8H); ¹³C NMR (125 MHz, DMSO-d6): δ 165.7, 165.5, 139.4, 139.2, 138.5, 134.9, 134.6, 133.8, 131.9, 131.7, 131.5, 139.3, 128.5, 128.3, 127.7, 123.7, 119.2, 119.8, 119.2, 116.1, 113.0, 112.9.

Note: integer integrals cannot be reported since the NMR spectrum represents a mixture of substances. Only resonances for the most major peaks are reported in the proton data along with relative ratios for proton integrals. Only the most prominent peaks are reported for ¹³C data.

The following data show a distribution of resonances that result from mixtures of halogenated compounds at a buffered pH of approximately 5.5 on Amide B. The following show one example of the ¹H NMRand ¹³C NMR at pH approximately 5.5:

¹H NMR (500 MHz, DMSO-d6): δ 10.48 (s, 5.0H), 10.40 (s, 0.4H), 10.32 (s, 2.5H), 10.22 (s, 0.7H), 8.32-8.35 (m, 1.3H), 8.09 (s, 0.6H), 7.95-8.04 (m, 23.6H), 7.83-7.90 (m, 2.2H), 7.48-7.64 (m, 37.2), 7.41-7.45 (m, 1.2H), 7.30 (t, J=8.0 Hz, 1.4H); ¹³C NMR (125 MHz, DMSO-d6): δ 165.6, 165.3, 139.4, 135.5, 134.9, 133.4, 133.1, 132.2, 131.6, 128.6, 128.4, 128.2, 128.1, 127.8, 127.5, 116.2, 113.

The above data at pH approximately 8 and approximately 5.5, based on both ¹H NMR and ¹³C NMR, show N-halogenation of Amide B as follows:

[chemical structure]

and these data at pH approximately 8 and approximately 5.5, based on both ¹H NMR and 13C NMR, show ring halogenations of Amide B as follows:

[chemical structure]

These data show that at carbon 1, halogenations occurs and carbon 3 is less likely to halogenate due to sterics.

### Example 7

This example describes a polyamide reverse osmosis composite membrane is formed on the surface of a porous polysulfone supporting membrane by a polycondensation reaction at the interface between an aqueous solution of m-xylylenediamine and a hydrocarbon solvent containing trimesoyl chloride. After the reaction is complete, the membrane is partially dried, rinsed and finally fully dried.

In a reverse osmosis test, the membranes were flushed with DI water at an applied pressure of 400 psi for four hours. Then, the feed was changed to 0.2 wt-% sodium chloride and permeate collected after four hours of operation. The three membrane samples exhibited the following water flux and sodium chloride rejection.

TABLE 4
Transport Properties

| Membrane | Flux (gal/ft2/day) | Salt Rejection (%) |
|---|---|---|
| 1 | 2.29 | 85.0 |
| 2 | 1.2 | 97.7 |
| 3 | 0.87 | 75.5 |

All of these three membranes along with an industry polyamide reverse osmosis membrane were exposed to a 500 ppm NaOCl solution at a pH of 8.5 for a different amount of hours to conclude if the membranes were chlorine resistant. The amounts of hours of exposure for hour tests were 21,000 ppm-hrs, 42,00 ppm-hrs, and 66,000 ppm-hrs. The industry polyamide reverse osmosis control membrane was exposed to the minimum 21,000 ppm-hrs of exposure since it is expressed in open literature that these membranes should not be exposed to more than 3,600 ppm-hrs of chlorine exposure. The control was tested before exposing it to our chlorine tests to obtain its flux and salt rejection before exposure and those numbers were of 11.73 gfd and 99.2% respectively.

Table 5 provides the transport properties after chlorine exposure and clearly shows the control industry polyamide membrane degraded from the exposure and therefore not chlorine resistant and all three of our new TMC/MXD membranes resulted in almost the same flux and salt rejection properties as seen before chlorination with only minor changes.

TABLE 5
Transport Properties After Chlorination

| Membrane | Flux (gal/ft2/day) | Salt Rejection (%) | Flux % Change |
|---|---|---|---|
| Control | 27.65 | 93.7% | 136% |
| 1 | 1.97 | 85.1% | 14% |
| 2 | 1.18 | 95.4% | 2% |
| 3 | 0.81 | 74.6% | 7% |

The foregoing detailed description is for the purpose of illustration. Such detail is solely for that purpose and those skilled in the art can make variations therein without departing from the spirit and scope of the invention.

What is claimed:

1. A halogen resistant polyamide comprising the reaction product of an amine and an acid chloride monomer wherein the stating amine monomer can be any amine having an aromatic ring structure and each amino group of said amine monomer is separated from the aromatic amine ring system by an alkyl group to minimize N-halogenations and ring halogenation at a pH range of approximately 7 to approximately 10.5.

2. The halogen resistant polyamide of claim 1 wherein the amine is selected from the group consisting of m-xylylenediamine, o-xylylenediamine; p-xylylenediamine; α,α′-dimethyl-1,3-xylylene diamine; α,α,α′,α′-tetramethyl-1,3-xylylene diamine; 1,3,5-tri(aminomethyl)benzene; and mixtures thereof.

3. The halogen resistant polyamide of claim 1 wherein said acid chloride monomer is selected from the group consisting of trimesoyl chloride (TMC), monofluorotrimesoyl (MFTMC), perfluorotrimesoyl chloride (PFTMC), nitrotrimesoyl chloride (NTMC), perchlorotrimesoyl chloride (PCTMC), 1,3,5-benzenetri-(difluoroacetoyl chloride);
isophthaloyl chloride (IPC) and mixtures thereof.

4. A halogen resistant membrane including a halogen resistant polyamide wherein said halogen resistant polyamide is a reaction product of an amine monomer and an acid chloride monomer wherein the amine monomer is modified with an alkyl group between each nitrogen and amine ring structure and the polyamide exhibits sufficient acitivity to (i) minimize ring halogenation and (ii) minimize N-halogenation at a pH range of approximately 7 to approximately 10.5.

5. The halogen resistant membrane of claim 4 wherein said amine monomer is selected from the group consisting of m-xylylenediame, o-xylylenediamine; p-xylylenediamine; α,α′-dimethyl-1,3-xylylene diamine; α,α,α′,α′-tetramethyl-1,3-xylylene diamine; 1,3,5-tri(aminomethyl)benzene; and mixtures thereof.

6. The halogen resistant membrane of claim 4 wherein said amine monomer is m-xylyldiamine.

7. The halogen resistant membrane of claim 4 wherein said acid chloride is selected from the group consisting of trimesoyl chloride (TMC), monofluorotrimesoyl (MFTMC), perfluorotrimesoyl chloride (PFTMC), nitrotrimesoyl chloride (NTMC), perchlorotrimesoyl chloride (PCTMC), 1,3,5-benzenetri-(difluoroacetoyl chloride); isophthaloyl chloride (IPC) and mixtures thereof.

8. A reverse osmosis desalination unit comprising a membrane support including a halogen resistant membrane comprising a halogen resistant polyamide wherein said halogen resistant polyamide is a reaction product of an amine monomer and an acid chloride monomer wherein the amine monomer is modified with an alkyl group between each nitrogen and amine ring structure to (i) minimize any halogenation on the amine ring and (ii) minimize N-halogenation at a pH range of approximately 7 to approximately 10.5

9. The reverse osmosis desalination unit of claim 8 wherein said amine monomer is selected from the group consisting of m-xylylenediame, o-xylylenediamine; p-xylylenediamine; α,α′-dimethyl-1,3-xylylene diamine; α,α,α′,α′-tetramethyl-1,3-xylylene diamine; 1,3,5-tri(aminomethyl) benzene; and mixtures thereof.

10. The desalination unit of claim 8 wherein said amine of the halogen resistant polyamide is m-xylyldiamine.

11. The desalination unit of claim 8 wherein said polyamide film is formed on another support such as polyetherimide (PEI).

12. The desalination unit of claim 8 wherein said acid chloride monomer of the halogen resistant polyamide is selected from the group consisting of trimesoyl chloride (TMC), monofluorotrimesoyl (MFTMC), perfluorotrimesoyl chloride (PFTMC), nitrotrimesoyl chloride (NTMC) perchlorotrimesoyl chloride (PCTMC), 1,3,5-benzenetri-(difluoroacetoyl chloride); isophthaloyl chloride (IPC), and mixtures thereof.
